(19) United States
(12) Patent Application Publication
(10) Pub. No.: US 2019/0360790 A1
(43) Pub. Date: Nov. 28, 2019

(54) Tail piece for remote delivery device and method of attaching same

(71) Applicant: PNEU-DART, INC., Williamsport, PA (US)

(72) Inventor: Blair D. Soars, Hughesville, PA (US)

(73) Assignee: PNEU-DART, INC.

(21) Appl. No.: 15/932,942

(22) Filed: May 24, 2018

(51) Int. Cl. F42B 12/54; A61D 7/00

(52) U.S. Cl. CPC F42B 12/54; A61D 7/00

(57) ABSTRACT

A remote delivery device is disclosed which has a tubular body and a tubular tail piece. The tail piece is adapted to telescope part way into body and has a plurality of stop members provided at a desired axial position. The stop members are located at spaced-apart locations around an outer circumferential surface of the tail piece and extend radially outwardly beyond an inside diameter of the body so that a forward tail end of the tail piece can be inserted into the body only to the location of the said stop members at the desired axial position. The body is crimped onto said tail piece at the desired axial position with a rearmost edge of the body abutting the stop members. With this modification to the stop members on the tail piece, axial expansion of said body caused by a crimping operation imparts less stress and axial force on the tail piece as compared to stress and force which would be imposed upon a tail piece which has a singular annular stop extending around an entire circumference of said tail piece. This results in reducing a rate of failure of said tail piece breaking off from said body when the remote delivery device is subjected to outside stresses or forces.

### BACKGROUND OF THE INVENTION

### 1. Field of the Invention

The present invention relates to an improved tail piece for a remote delivery device best known as a Dart (hereinafter “RDD”) and method of attaching the same. More specifically, it relates to a tail piece having an improved structure which is attached to main body of an RDD in a manner which reduces stress on the tail piece thereby reducing occurrences of the tail piece breaking off from the main body.

### 2. Description of the Prior Art

The state of the prior art is set forth in applicant's earlier U.S. Pat. No. 9,234,729 issued Jan. 12, 2016 for “Improved Injection Dart” which patent is hereby incorporated herein by reference thereto. In U.S. Pat. No. 9,234,729 applicant described an injection dart which provided a flow restrictor to control the rate of flow of an injection from such a device to reduce tissue damage. The various references cited in such patent are still believed to provide a current view of the state of the art with respect to RDDs.

All RDDs include a main body into which the injectable liquid to be dispensed is loaded. With smaller RDDs (one typically utilized to dispense from 0.5 to 2 cc. of medication) the main body is preferably formed of plastic resin and with larger RDDs (utilized to dispense from 3 cc. to 10 cc. of injectable liquid) the main body of the RDD is preferably formed of aluminum. The main components of a typical RDD include a stainless cannula, gelatin collars, an aluminum nose cone, a plastic resin or aluminum main body and a plastic resin tail piece as shown in the website of Pneu-Dart at http://www.pneudart.com/products/rdddevices/how-rdds-work/ and such components are well known in the art.

The accuracy of an RDD when discharged or shot from a projector (whether it be a gauged CO2 projector, a cartridge fired projector or a compressed air projector) is highly dependent upon the manufacturing precision of the RDD components and their assembly.

One form of a commercially available RDD utilizes an aluminum tubular body which has a rear end crimped onto a plastic resin tubular tail piece. The tail piece includes an annular stop which fully encircles the reward portion of the tail piece. A forward end of the tail piece is inserted into the rear end of the aluminum body to the location of the annular stop and then the body is crimped onto the tail piece. If the tail piece and the body are in perfect axial alignment, the crimping operation generally is effective in forming a strong bond and connection between such components.

However, in some instances, if the tail piece and the body are not in perfect axial alignment, the crimping operation causes an axial deformation of the rear end of the aluminum body which pushes against the annular stop with considerable force. Because the annular stop fully encircles the tail piece, the rearmost end of the aluminum body contacts and abuts the stop around the entire circumference of the annular stop. In this configuration, any rearward axial deformation of the body against the annular stop applies pressure all the way around the tail piece.

In some instances, this pressure causes the plastic resin tail piece to be put under stress such that the tail piece can break off from the body over time. Such a failure, even though the rate of failure is not high, is undesirable and there remains a need from an improved RDD which has a tail piece connected to a main body in a manner which causes less stress upon the tail piece and is less likely to have the tail piece break off from the body.

### SUMMARY OF THE INVENTION

This invention relates to a remote delivery device comprising a tubular body and a tubular tail piece, said plastic resin tail piece adapted to telescope part way into body, said plastic resin tail piece having a plurality of stop members provided at a desired axial position, said stop members being located at spaced-apart locations around an outer circumferential surface of said tail piece, said stop members extending radially outwardly beyond an inside diameter of said body whereby a forward tubular tail end of said tail piece can be inserted into said body only to said stop members at said desired axial positions, said body being crimped onto said tail piece at said desired axial position with a rearmost edge of said body abutting said stop members.

Preferably axial expansion of said body caused by a crimping operation imparts less stress and axial force on said tail piece as compared to stress and force which would be imposed upon a tail piece having a singular annular stop extending around an entire circumference of said tail piece whereby reducing a rate of failure of said tail piece breaking off from said body when subjected to the imposed stresses of an irregular crimp condition or outside forces.

Said outside forces may be caused by a discharge of said remote drug delivery device from a projector into an animal or target or by shipping or handling of the RDD.

Preferably, said tail piece includes an annular O-Ring groove into which a rear end of said body is crimped over and around an installed O-Ring. The annular groove includes a rearward facing solid wall surface, a groove floor surface having an outer diameter less than an outer diameter of said forward tail end, and a partial forward-facing wall comprised of said spaced-apart stop members. Preferably, said partial forward-facing wall comprises spaced-apart stop member which in combination extend around about 50% said circumferential surface of said tail piece. Preferably, said stop members comprise four spaced apart stop members, each stop member extending approximately 45 radial degrees symmetrically around said tail piece thus providing four spaced apart radial locations where said stop members contact a rearmost edge of said main body and four spaced apart radial locations where no such contact occurs.

Preferably, partial forward-facing wall comprises spaced-apart stop member which in combination extends around between 30% and 70% of said circumferential surface of said tail piece.

Preferably, said main body is formed of aluminum and said tail piece is formed of formed of plastic resin.

In one form of the invention, a remote delivery device is provided comprising:

a) a tubular body having a forward body end and a rear body end; and

b) a tubular tail piece inserted into said rear body end of said tubular body.

said body having a rear end thereof mechanically crimped onto said tail piece to secure said tail piece to said body, said tail piece having tubular forward tail end having an outer diameter smaller than an inner diameter of said rear body end allowing said forward tail end to be inserted into said rear body end, said forward tail end also including a plurality of stop members located at spaced-apart locations around an outer circumferential surface of said tail piece defining a rearmost portion of said forward tail end, said stop members having an outer diameter larger than said inner diameter of said rear body end whereby only the forward tail end of said tail piece can be inserted into said rear body end and said tail piece is crimped at a desired axial position relative to said body, said stops having a forward stop surface forming a partial forward-facing wall which collectively abuts a rearmost edge of said rear body end at about 50% of the circumference of said rearmost edge whereby stress on said tail piece caused by axial expansion of said rearmost edge is reduced.

A method of attaching a tubular tail piece to a tubular body of a remote delivery device is also disclosed comprising the steps of:

providing a tubular body having an inside diameter;

providing a tubular tail piece tube having an outside diameter smaller than said inside diameter of said body, said tail piece having a plurality of stop members provided at a desired axial position, said stop members being located at spaced-apart locations around an outer circumferential surface of said tail piece, said stop members extending radially outwardly beyond said inside diameter of said body;

inserting a forward end of tail piece telescopically into said body to until a rearmost edge of said body contacts said stop members at said desired axial position; and

crimping said body onto said tail piece at said desired axial position with portions of said rearmost edge of said body abutting said stop members and other portions of said rearmost edge not in contact with said stop members.

### BRIEF DESCRIPTION OF THE FIGURES

FIG. 1 is a side elevational view of the remote delivery device of the present invention including an improved tail piece.

FIG. 2 is a side elevational view of the remote delivery device with a stabilizer support flange and flight stabilizer attached.

FIG. 3 is a perspective view of the remote delivery device of FIG. 2.

FIG. 4 is an exploded perspective view showing a body and tail piece having spaced apart stop members according to the present invention prior to insertion and crimping.

FIG. 5a is a side elevational view of a prior art remote delivery device including a stop member which extends around the entire circumference of the tail piece.

FIG. 5b is an end elevational view of the prior art RDD of FIG. 5a.

FIG. 5c is a perspective view of the prior art RDD of FIG. 5a.

FIG. 6a is a side elevational view of the improved tail piece of the present invention including a plurality of spaced-apart stop members.

FIG. 6b is an end elevational view of the RDD of FIG. 6a.

FIG. 6c is a perspective view of the RDD of FIG. 6a.

FIG. 7 is a perspective view of the improved tail piece of the present invention with an RDD body crimped onto the tail piece.

### DETAILED DESCRIPTION OF THE PREFERRED EMBODIMENTS

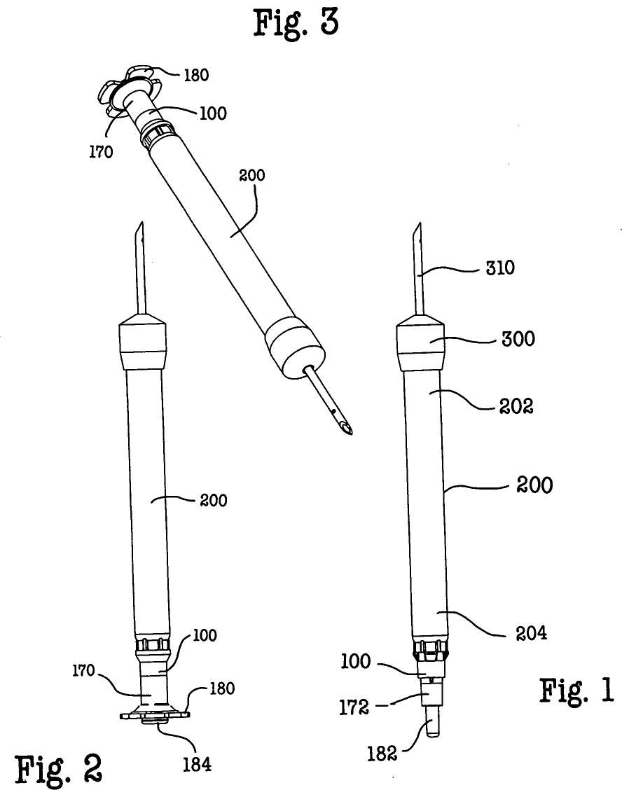

Referring to FIG. 1, a side elevational view of a typical partially assembled remote delivery device of the type for which the present invention is best intended. This device includes a tubular body 200 preferably formed of aluminum. The body 200 includes a forward end 202 and rear end 204. A forward end cap 300 is provided into which a cannula 310 is mounted. The body 200 contains a reservoir into which a desired injectable liquid to be dispensed is stored by means well known in the art. FIG. 1 also shows an improved tail piece 100. Tail piece 100 includes a tail piece portion 172 on which a stabilizer support flange 170 is mounted and an end post portion 182 which is utilized to secure a stabilizer 180.

Referring to FIGS. 2 and 3, a fully assembled remote delivery device is shown to illustrate the overall design of such devices. In addition to the components shown above in FIG. 1, this view also shows the location of a stabilizer support flange 170 and stabilizer 180. The post forward end portion 182 of the tail piece 100 is mounted or otherwise formed into a button 184 which secures the stabilizer 180 onto the rear end 204 of the RDD.

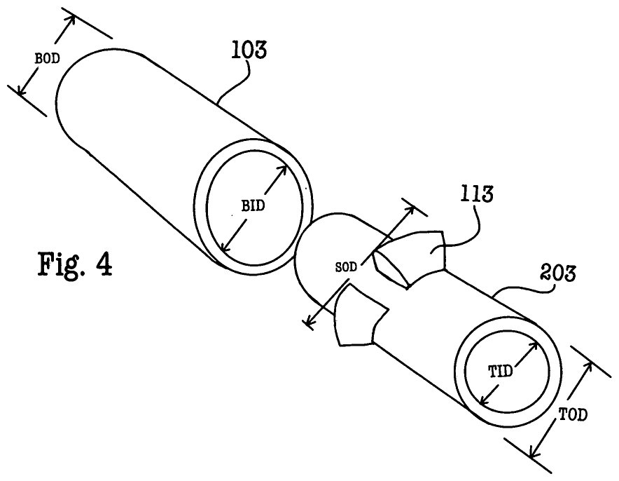

FIG. 4 shows an exploded view of the tubular body 103 and a tubular tail piece 203 according to the present invention. The tubular tail piece 203 includes a plurality of spaced-apart stop members 113. The tubular body 103 includes a body inner diameter (BID) and a body outer diameter (BOD). The tail piece 203 includes a tail piece inner diameter (TID) and a tail piece outer diameter (TOD). Obviously, for the tail piece to telescope into the body, the TOD must be smaller than the BID. The stop members 113 extend radially outward from the tail piece and the stop members create a stop member outer diameter (SOD). For the stop members 113 to function properly, the SOD must be larger than the BID and is also preferably larger than the BOD. In this way, the forward end of the tail piece can be inserted into the body 103 only to the location of the stop members 113. Once the tail piece is inserted the stop members 113 to a desired axial location, the body is then crimped onto the tail piece by means well known in the art.

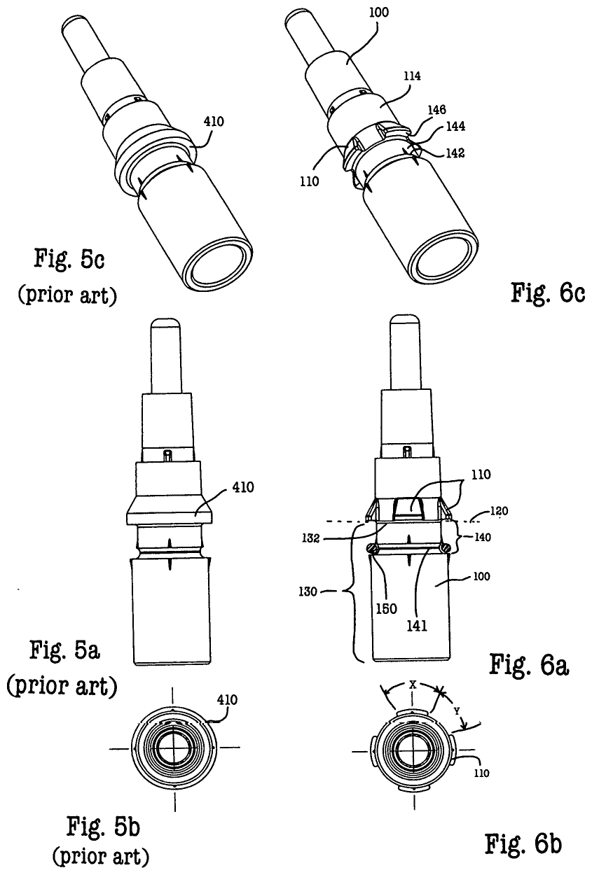

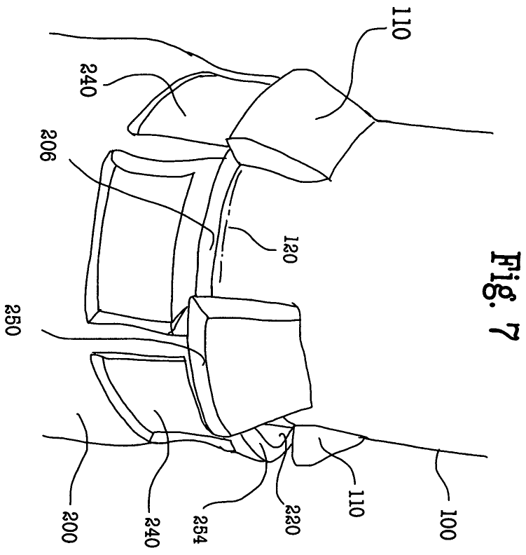

Referring to FIGS. 5a, 5b and 5c, a prior art tail piece is shown. This tail piece is identical to the improved tail piece shown in FIGS. 6a, 6b and 6c but for the stop member 410 of the prior art fully encircles the tail piece whereas the stop members 110 of the present invention are provided at spaced apart locations around the circumference of the tail piece. Referring more specifically to FIG. 6a, the tail piece 100 includes a plurality of stop members 110 provided at spaced apart locations around the tail piece. The stop members 110 define a desired axial position 120. As shown the tail piece has a forward end portion 130 which is designed to be inserted into a body of an RDD. The portion 130 has a rearmost end 132 located at the desired axial position 120. Preferably, the tail piece includes a groove 140.

Referring to FIG. 6c, the groove 140 includes a rearward wall surface 142, a groove floor 144 and a partial forward-facing portion or forward stop surface 146 created by the stop members. The stop members 110 are provided on and extend radially outward from an outer circumference 114 of the tail piece 100.

As best shown in FIG. 6b, the stop members 110 each extend a radial distance X around the circumference and the space between the stop members extend a radial distance Y. Preferably, only four (4) stop members are provided around the circumference of the tail piece. When this is the case as is shown in FIG. 6b, the radial distance X will be equal to 45° and the radial distance Y will also be equal to 45°. It will be obvious to those skilled in the art that if one wished to provide eight (8) stop members, for example, rather than four (4) stop members than each of these radial distances would be half as long, namely 22.5°. FIG. 6b also shows the location of an O-ring 150 (shown in section) which is seated in a shallow U-shaped channel 141 provided in a rearward portion of groove 140.

Additionally, although it is preferred that the present invention include stop members 110 which extend around approximately 50% of the circumference of the tail piece, applicant has discovered that the invention provides a reduction in stress to the tail piece if the stop members extend anywhere from 30% to 70% of the distance around the circumference. For example, if the stop members were provided each member having a radial distance of 27° and each stop member being spaced-apart by a radial distance Y of 63° then such an arrangement would provide stop members which extend around 30% perimeter or circumference of the tail piece 100. Alternatively, if four (4) stop members were provided each extending a radial distance X of 63° with a space between them of Y being equal to 27°, in this instance, the stop members 110 would extend around 70% the perimeter. It will be obvious to those skilled in the art that the number of stop members and distance between them can be varied in many ways but in order for the present invention to significantly reduce stress on the tail piece it is believed that stop members extending between 30° and 70° around the perimeter is required with stop member extending around 50% of the circumference being considered ideal.

As will be well understood the provision of a groove 14 shown in FIGS. 6a, 6b and 6c, provides a space into which the installed O-Ring 150 can seat itself and the metal of the rear end of the body may be crimped providing a sealed and aerodynamic RDD.

Referring to FIG. 7 the material (typically aluminum) of the body is crimped at spaced apart locations 240 around the perimeter of the rear end of the body 204 to affix the tail piece 100 onto the body 200. As shown, the rearmost edge 206 of the body 200 is in contact with the stops 110 only at some radial locations designated 250. There are also radial locations 254 where the rearmost edge 206 of the body does not contact the stops 110 at all. It is this lack of contact that is believed to result in a reduction of stress to the tail piece 100. As can be seen, the stop members 110 must extend radially outward at least beyond the inside surface 220 of the main body function as a stop member and to align the tail piece at the desired axial position 120. Because the crimping operation may cause some degree of axial expansion of the metal at the location of the rearmost edge 206 of the body, provided spaces or locations 254 where the body does not contact the stop members is believed to result in a reduction in this axial force on the tail piece and decrease the rate of failure of a tail piece 100 breaking off from the body 200 under stress.

In practice, prior to the present invention, stop members consisted of a single annular stop 410 which fully encircled the tail piece as shown in FIGS. 5a, 5b and 5c. With this prior art stop member, the rearmost edge 206 of the body would be in contact all the way around the entire perimeter of the stop member 410 and all rearward axial forces imparted by a crimping operation would be directed into the stop 410 increasing the stress on the tail piece.

While this change might at first appear somewhat trivial it has a real and unexpected benefit in practice. The art of manufacturing remote delivery devices is a very difficult process which requires precise manufacturing tolerances. An RDD is a complex device which is literally shot from a projector at a high velocity, flies through the air and into the body of an animal and then dispenses an injectable liquid at a controlled rate. The mechanics of such a device is highly technical and the amount of force which the RDD is subject to especially during the actual discharge from the projector is enormous. By providing an RDD which has a tail piece which is less likely to break off greatly increases the effectiveness of the device and allows for increased performance for both the animal to which medications need to be administered and to the operators who discharges the projector and delivers the RDD into the animal.

While not specifically mentioned earlier, it is highly desirable that the stop members regardless of the number be provided in a symmetrical pattern around the circumference of the tail piece. Because these devices are designed for accurate flight, having a symmetrical design is believed to be highly advantageous.

It is to be understood that while certain forms of the present invention have been illustrated and described herein, the present invention is not to be limited to the specific forms or arrangements of parts described and shown.

I claim:

1. A remote delivery device comprising a tubular body and a tubular tail piece, said tail piece adapted to telescope part way into body, said tail piece tube having a plurality of stop members provided at a desired axial position, said stop members being located at spaced-apart locations around an outer circumferential surface of said tail piece, said stop members extending radially outwardly beyond an inside diameter of said body whereby a forward tail end of said tail piece can be inserted into said body only to said stop members at said desired axial position, said body being crimped onto said tail piece at said desired axial position with a rearmost edge of said body abutting said stop members.

2. A remote drug delivery device according to claim 1 whereby axial expansion of said body caused by a crimping operation imparts less stress and axial force on said tail piece as compared to stress and force which would be imposed upon a tail piece having a singular annular stop extending around an entire circumference of said tail piece whereby reducing a rate of failure of said tail piece breaking off from said body when said remote delivery device is subjected to outside stresses or forces.

3. A remote delivery device according to claim 1 wherein said tail piece includes an annular groove into which an O-Ring is installed and rear end of said body is crimped.

4. A remote delivery device according to claim 3 wherein said annular groove includes a rearward facing solid wall surface, a groove floor surface having an outer diameter less than an outer diameter of said forward tail end, and a partial forward-facing wall comprised of said spaced-apart stop members.

5. A remote delivery device according to claim 4 wherein said partial forward-facing wall comprises spaced-apart stop member which in combination extend around about 50% said circumferential surface of said tail piece.

6. A remote delivery device according to claim 5 wherein said stop members comprise four spaced apart stop members, each stop member extending 45 radial degrees symmetrically around said tail piece thus providing four spaced apart radial locations where said stop members contact a rearmost edge of said main body and four spaced apart radial locations where no such contact occurs.

7. A remote delivery device according to claim 4 wherein said partial forward-facing wall comprises spaced-apart stop member which in combination extends around between 30% and 70% of said circumferential surface of said tail piece.

8. A remote delivery device according to claim 1 wherein said main body is formed of aluminum.

9. A remote delivery device according to claim 1 wherein said tail piece is formed of formed of polycarbonate.

10. A remote delivery device comprising:
a) a tubular body having a forward body end and a rear body end; and
b) a tubular tail piece inserted into said rear body end of said tubular body,
said body having a rear end thereof mechanically crimped onto said tail piece to secure said tail piece to said body, said tail piece having tubular forward tail end having an outer diameter smaller than an inner diameter of said rear body end allowing said forward tail end to be inserted into said rear body end, said forward tail end also including a plurality of stop members located at spaced-apart locations around an outer circumferential surface of said tail piece defining a rearmost portion of said forward tail end, said stop members having an outer diameter larger than said inner diameter of said rear body end whereby only the forward tail end of said tail piece can be inserted into said rear body end and said tail piece is crimped at a desired axial position relative to said body, said stops having a forward stop surface forming a partial forward-facing wall which collectively abuts a rearmost edge of said rear body end at about 50% of the circumference of said rearmost edge whereby stress on said tail piece caused by axial expansion of said rearmost edge is reduced.

11. A method of attaching a tubular tail piece to a tubular body of a remote delivery device comprising the steps of:
providing a tubular body having an inside diameter;
providing a tubular tail piece tube having an outside diameter smaller than said inside diameter of said body, said tail piece having a plurality of stop members provided at a desired axial position, said stop members being located at spaced-apart locations around an outer circumferential surface of said tail piece, said stop members extending radially outwardly beyond said inside diameter of said body;
inserting a forward end of tail piece telescopically into said body to until a rearmost edge of said body contacts said stop members at said desired axial position; and
crimping said body onto said tail piece at said desired axial position with portions of said rearmost edge of said body abutting said stop members and other portions of said rearmost edge not in contact with said stop members.
